(19) United States
(12) Patent Application Publication
(10) Pub. No.: US 2019/0259013 A1
(43) Pub. Date: Aug. 22, 2019

(54) SYSTEM AND METHOD FOR EMPLOYER PROVIDED FINANCIAL SERVICES

(71) Applicants: Clint Armstrong, Santa Ana, CA (US); Steve Vierra, Santa Ana, CA (US)

(72) Inventors: Clint Armstrong, Santa Ana, CA (US); Steve Vierra, Santa Ana, CA (US)

(21) Appl. No.: 16/278,013

(22) Filed: Feb. 15, 2019

Related U.S. Application Data
(60) Provisional application No. 62/631,917, filed on Feb. 18, 2018.

(51) Int. Cl. G06Q 20/20; G06Q 20/18; G06Q 20/40

(52) U.S. Cl. CPC G06Q 20/206; G06Q 20/40145; G06Q 20/18

(57) ABSTRACT

A method begins with an employer receiving identification information associated with an employee and continues with the employee being identified and authorized to use an automated services system. The method continues with the automated services system receiving pay data associated with the employee, including compensation owed to the employee, and based on the at least the pay data providing options for the user. When one of the options includes payment disbursal, the method continues with the system authorizing an automated kiosk to disburse payment to the employee.

### CROSS REFERENCE TO RELATED APPLICATIONS

This application claims benefit of U.S. Provisional Patent Application No. 62/631,917 filed on Feb. 18, 2018, entitled as “System and Method for Employer Provided Financial Services”, which is incorporated herein by reference in its entirety.

### FIELD

Some embodiments relate to providing automated services to employees.

### BACKGROUND

Unless otherwise indicated herein, the materials described herein are not prior art to the claims in the present application and are not admitted to be prior art by inclusion in this section.

Traditional financial services are often limited to individuals with minimum qualifications and capabilities for using those services. These qualifications may include credit worthiness, technical sophistication, travel restrictions, disposable time and status, along with other real or imagined obstacles. Security and data privacy concerns can also be significant challenges, because traditional identity instruments may not be available and/or due to pervasive mistrust of financial institutions. Depending on the type and scale of their businesses, employers may employ individuals with needs and interests that could benefit from those services if the impediments were removed.

An employer may provide access to various services for their employees in the course of providing employment, removing some or all of the obstacles that prevent or discourage employees from benefiting from participation.

The subject matter claimed herein is not limited to embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described herein generally relate to a system for providing automated services to an employee or contractor (hereinafter “employee”). For some of the example embodiments the systems operate on a private network.

In an example embodiment, an employee is authenticated inside an employer's private network using a kiosk on company premises, and based on the employee's employment status, such as current payroll data, eligibility, etc., payment, along with other services, and pay documentation, is disbursable in a variety of forms. The employer is able to offer a variety of services, while reducing distractions to employees and increasing employee efficiency and job satisfaction.

In yet another example embodiment, the employee is authenticated using a combination of a kiosk and the employee's own or provided wirelessly connected device, followed by disbursal of payment in a form acceptable to the employee, along with other services, including services provided by third parties. Access to third party services may be brokered by the employer to maintain security and may also include the employer operating for the employee as a surrogate, even to the extent of providing anonymity for the employee as regards the third party.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

A further understanding of the nature and advantages of the present invention may be realized by reference to the remaining portions of the specification and the drawings wherein like reference labels are used throughout the several drawings to refer to similar components. In some instances, reference labels include a numerical portion followed by a latin-letter suffix; reference to only the numerical portion of reference labels is intended to refer collectively to all reference labels that have that numerical portion but different latin-letter suffices. The invention will be described and explained with additional specificity and detail through the use of the accompanying drawing, in which:

FIG. 1 is a schematic block diagram of an embodiment of a system for providing automated services to employees within a private network;

FIG. 2 is a perspective view of an example kiosk in accordance with the present invention;

FIG. 3 provides an overview of the various components of a timecard module in accordance with the present invention;

FIG. 4 is a logic diagram of an example of a method for collecting employee information in accordance with the present invention;

FIG. 5 is a schematic block diagram of an embodiment of financial module in accordance with the present invention;

FIG. 6 is a logic diagram of an example of a method for providing automated services in accordance with the present invention;

FIG. 7 is an example of an interactive display for use by an employee to make selections in accordance with the present invention; and

FIG. 8 is another example of an interactive display for use by an employee to make selections in accordance with the present invention.

### DETAILED DESCRIPTION OF SOME EXAMPLE EMBODIMENTS

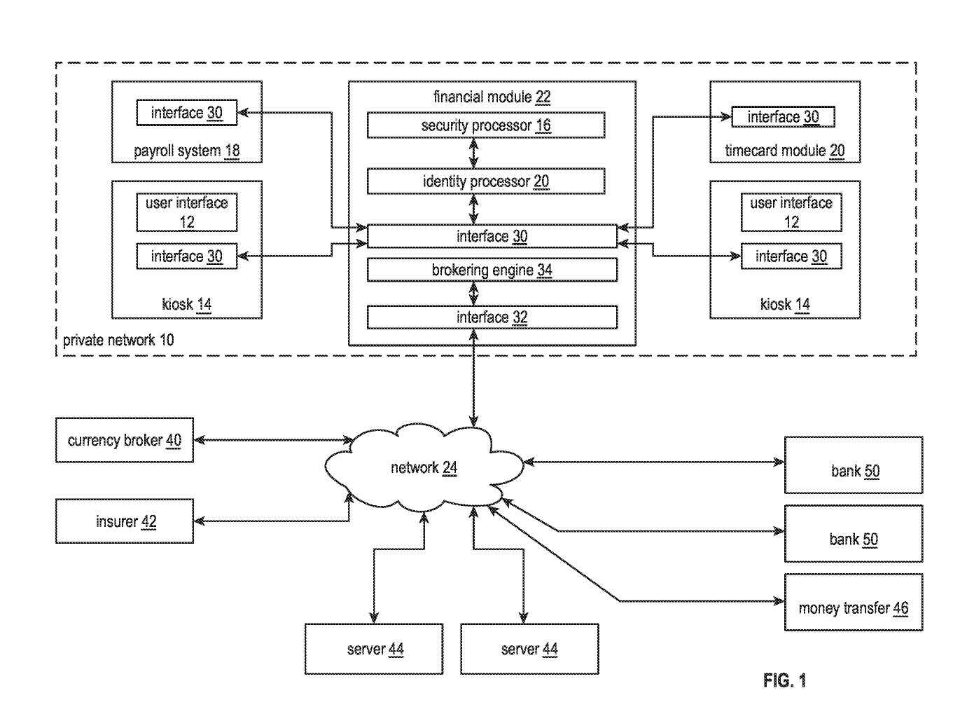

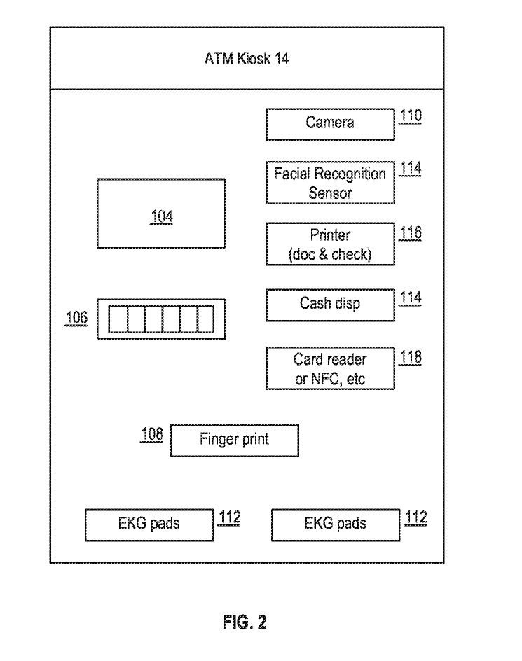

FIG. 1 is a schematic block diagram of an embodiment of a system for providing automated services to employees within a private network 10 that includes kiosks 14 coupled to a financial module 10. The kiosks 14 include employee interface 12 for displaying information to employees along with employee input devices, including, but not limited to keyboards, cameras, biometric devices, etc, that will be disclosed with more specificity in FIG. 2 below. Financial module 22 includes security processor 16, along with identity processor 20. Although depicted as separate schematic elements, security processor 16, and identity processor 20 may be implemented as a single element, where the security processing includes an identity processing function. Security processor 16 may also include one or more storage devices (not shown), either internal to the security processor 16, or securely coupled to security processor 16, where the storage devices contain necessary libraries of authentication data and other resources necessary for identification and authentication of employees. Security processor may incorporate secure elements to prevent and/or discourage access to authentication data stored by the system, along with secure communication facilities to prevent access to authentication data being transported within private network 10.

Financial module 22 includes interface 30 for coupling to system elements within private network 10. Private network 10 may be in a single geographic location, as depicted, or as a virtual private network (VPN) with geographically separated elements. Moreover, interface 30 is depicted as a single element, however it may be implemented using a number of communication elements to provide security and limited access, including encryption necessary to provide communication over VPN, all of which are meant to be incorporated in interface 30. Additionally, interface 30 may be incorporated with any of the elements of the private network 10 as a module within a single hardware device, or as a module within an integrated circuit or as a module in an integrated circuit package.

Payroll system 18 includes payroll data associated with each employee, including data from timecard module 20, pay rate and employment terms for each employee, and data sufficient to provide payroll documentation for required government systems. Payroll system 18 is depicted as a standalone element, however it may be incorporated as a module function within financial module 10. Payroll system 18 may also incorporate timecard module 20 as a single system. Payroll system 18 may include one or more storage devices as necessary to store employee payroll data, along with computing resources necessary to determine payment data. All or part of the functions of payroll system 18 may alternatively be provided by a third-party vendor, such that data provided from elements in private network 10 is transmitted to the third-party vendor and in such a case payroll system 18 is meant to depict an interface to such third-party vendor. Third party vendors may provide cloud-based storage for the payroll system, as well as customer relationship management (CRM) and operations software for both employee staffing and payroll. Third party application programming interface (API) services may also be used by an employer to develop the interface and employee services for the various embodiments of the subject system.

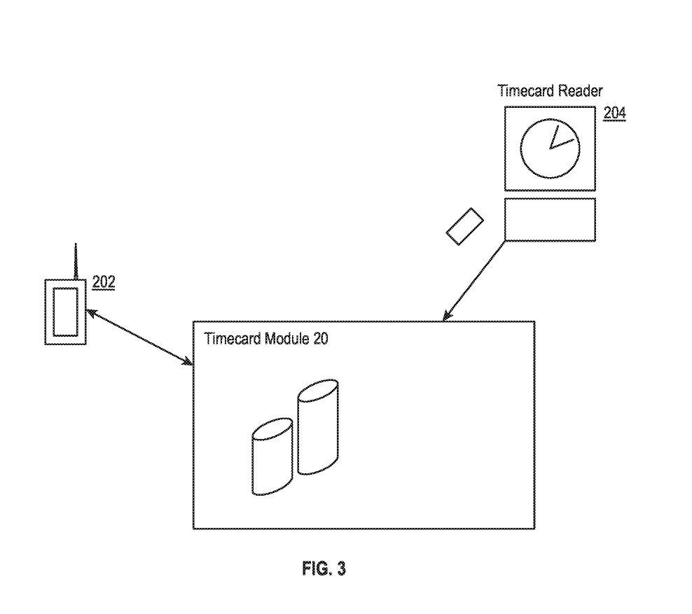

Timecard module 20 includes interface 30 for coupling to financial module 10 and/or other elements in the private network, including, but not limited to the payroll system 18 and the kiosks 14. Timecard module 20 is disclosed with more specificity as regards FIG. 3.

While kiosks 14 are used for financial transactions, the financial transactions are executed within an employer's private network and while an employer may be able to connect to an outside financial institution, such as a bank, the employer is always between the employee and the outside financial institution. Accordingly, the kiosk is not deployed by a bank, and is, thus, limited to services provided by the employer. A kiosk may also be implemented as a wirelessly connectable device, as discussed in detail below, but in all cases the interaction is between the employer provided network and the employee and therefore subject to an employer/employee relationship.

Financial module 22 includes interface 32 for providing access to systems outside the private network, including service from third party vendors/providers. Using interface 32 financial module 22 may execute a variety of functions vis-à-vis the third-party vendors/providers, including, but not limited to brokering the use of the third-party services for employees. Brokering services may include, for example, using the employer customer status to secure services from such third-party services for an employee. Examples include providing a guarantee for an employee to use the services where services require a financial commitment, and operating as a surrogate for the employee/employee, so that the employee is anonymous from the perspective of a third party. Where third party services require data specific to an employee, financial module 22 may provide a data masking function to ensure that the employee's identification data is not available to a third party.

Third party services may include, but are not limited to, banking services such as use of a card to access third party automated teller machines. Additional examples include the use of money transfer services 46, currency broker 40, insurer 40, servers 44 and banks 50.

FIG. 2 is a perspective view of an example kiosk 14 from FIG. 1 incorporating example employee interfaces. Display 104, which may be a used to provide employee instructions as required for authentication and options for use of the system. Keyboard 106 and/or card reader 118 can be used to provide employee input in addition to or instead of various biometric sensors that may or may not be included, such as facial recognition sensor 114, fingerprint sensor 108, camera 110 and EKG pads 112. Card reader 118 may function with various cards, including employee identification cards, bank cards, credit cards and even a driver license, among various alternatives. In each case, a sensor may be used alone, or in combination, to provide biometric data for the identity processor 20 and/or security processor 16 from FIG. 1. Biometric data may be transmitted unaltered to financial module 22 from FIG. 1, or alternatively, it may be processed by one or more modules in the kiosk and transmitted in a converted form to financial module 22.

Revisiting FIG. 1, biometric sensors are used to capture employee biometric data that is transmitted to identity processor 20 and/or security processor 16, where it is compared to established authentic data in a database. In one example an employee approaches kiosk 14, which either captures biometric data from the employee or instructs the employee to provide other employee input (directly or through a wirelessly connected device) that is transmitted to the identity processor 20. The biometric data or employee input information is then compared to authentication data accessible by identity processor 20 and once a match is made, security processor 16 transmits a challenge to the kiosk 14. Kiosk 14 then collects the required challenge answer, which may be biometric data, employee input of a password or other verification response. It is important to note that the answer to the challenge question may be collected automatically from the employee, from the employee wirelessly connected device, or it may be in response to a displayed or audio request from kiosk 14.

Access to financial module 22 using a wirelessly connectable device may be limited using GPS or RFID technology to create a virtual geographic boundary in order to provide additional security or functionality. For example, an employee using a wirelessly connectable device may be logged in and out of the system automatically based on their location within a permitted area.

Kiosk 14 may work alone or in conjunction with financial module 22 to characterize and track an employer/employee's preferences. Examples include executing a learning system to predict employer/employee choices and efficiency. For example, one or more system modules could be used to track an employee's work schedule and/or assign one or more time slots for the employee to use kiosk 14 when there will be no waiting period. According to another example, the employer may notify the employee when payment is available and even schedule use of kiosk 14 based on when payment is allowed and/or possible. Pay periods for an employee could be determined by one or more system modules based on employee preferences and/or the employer needs, such that payment could take place at any meaningful increment, such as weekly, daily, or even hourly.

Financial module 22 may be controlled by the employer/owner meet various objectives, including, for example, programming system components to allow an employee to receive a portion of payment for a particular pay period early, or allow only a portion, as dictated by government withholding requirements or an employee's 3^{rd} party obligations. Financial module 22 may also be adapted to provide updated information on third party or employee provided programs, such as 401K or profit sharing programs. Payment could take any form, including Bitcoin, gift cards, etc. or the payment could be authorized to a third party via money transfer, or directly to another employee.

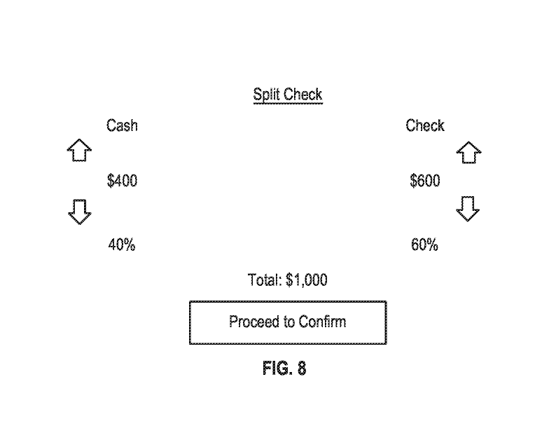

An employer may also want to provide pay advances or loans to an employee using the system of FIG. 1. Accordingly, the employer could put incorporate rules and safeguards into the system to allow for automated execution of the pay advances or loans using the system. Rules may include a maximum loan or pay advance based on a payment term, or assurances such as a hold on a credit card or other financial instrument. An employee may want to provide collateral for a loan in advance that could be taken into account when a loan or pay advance is requested. Additional features and details are provided with reference to FIG. 8 below.

Returning to FIG. 2, once an employee is authenticated, multiple services may be offered, including receipt of cash from cash dispenser 114, or a printed check from printer 116, or a combination, depending on employee preferences or based on payment rules established by the employer. Printer 116 may be used to output documentation for employees, including, for example, timecard information, W-2 information such as taxes payed or estimated, withdrawals for insurance, account balance, etc. Printer 116 may also be used in combination with display 104 to provide desired payroll and financial information to employees. Card reader 118 may also be adapted to, for example, load money on a debit card, dispense a pre-paid debit card, dispense a prepaid credit card or virtually any financial operation normally associated with physical payment platforms.

In some embodiments card reader 118 may be used as authorization device for other services and application, such as third-party payment applications executed on a wirelessly connectable device. Examples include government services, such as unemployment payment, disability payment or health related services. Additionally, employees may prefer to maintain some or all of their compensation over cloud-based services, such as mobile payment service so that it can be used to directly pay for employee necessities. In such a case card reader may alternatively be used to communicate with an employee's wirelessly connectable device using one of the wireless connectivity methods detailed below.

In situations where an employee has a company provided or personal wirelessly connectable device, many of the functions of kiosk 14 could be performed using the wirelessly connectable device. For example, one or more of the biometric sensors and/or employee input could be done on the wirelessly connectable device. In one example the employee uses the wirelessly connectable device to identify the employee to the kiosk. This may be accomplished, for example, using an NFC reader on kiosk 14, or alternatively kiosk 14 may incorporate a Bluetooth, WiFi, Zigbee, or any other acceptable communication medium. In one example kiosk 14 would be adapted to incorporate a standard or defacto standard communication protocol to communicate with the wirelessly connectable device. In another example, the wirelessly connectable device would incorporate a proprietary application to allow for communication with kiosk 14. In yet another example, kiosk 14 may be adapted to receive communication from an employee's wirelessly connectable device via WAN interface 32, where the wirelessly connectable device is connected to a third-party network.

The wirelessly connectable device may also be used in combination with kiosk 14 to load payment directly to a third-party account using the NFC reader or alternate payment scheme.

FIG. 3 provides an overview of the various components of a timecard module. Timecard reader 204 may be manual system using timecards or it may incorporate a keypad and require input of a personal identification number. Wirelessly connectable device 202 may also be used to input timecard data, or a combination of reader 204 and wirelessly connectable device 202 may be used for timecard tracking. In one example, wirelessly connectable device 202 is used in combination with an NFC reader to input timecard data. Regardless of the methodology used to track timecard, timecard data collected is input over interface 30 of FIG. 1 to financial module 22. Timecard module 20 may include one or more storage devices, either incorporated within timecard module 20 or otherwise coupled to it.

As with the payroll system 18 from FIG. 1, one or more functions of the timecard module 20 may be provided by a third-party vendor, such that timecard tracking functions are provided the third-party vendor and in such a case the timecard module 20 is meant to depict an interface to such third-party vendor. Third party vendors may provide cloud-based storage for timecard tracking, as well as customer relationship management (CRM) and operations software and even application programming interface (API) services that may be used by an employer to develop interfaces and employee services for the various embodiments of the timecard module and function.

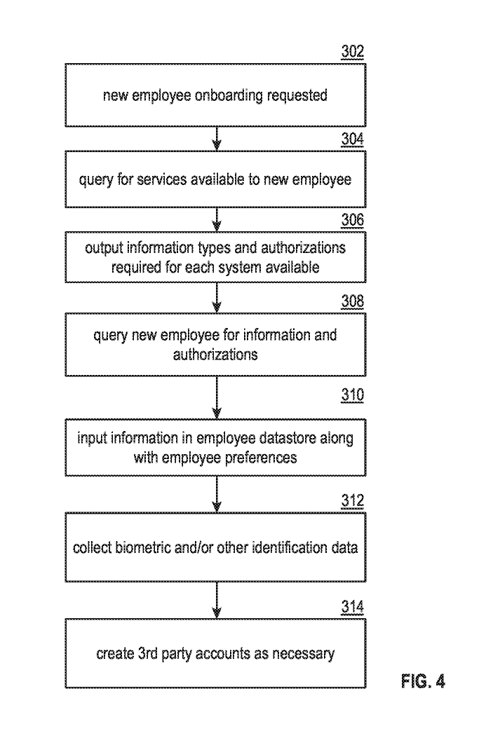

FIG. 4 is a logic diagram of an example of a method for collecting employee information in accordance with the present invention. In step 302 a new employee is presented for onboarding; in step 304 the system is queried to determine which employer and third-party services are or will be available to the employee. This determination may be made based on the employment level, qualifications, or other criteria as established by the employer. In some cases, an employee will have to meet length of service or other criteria in order to be eligible for one or more services, in this case the employer may want to collect the requisite information during the onboarding process and message the employee using the financial module or other module to inform the employee when such services are now within an eligible window.

The method continues with step 306, wherein the necessary forms and authorization requests for available services are output. The system may additionally provide criteria for services not currently available to the new employee, along with rules for eligibility for each of those services. The method continues by querying the new employee or onboarding officer for the information and authorizations identified in step 306. The requested information, authorizations are then input in step 310, along with employee preferences for using the automated services system. Some or all of the information may be parsed from a resume or other identifying document. The employer may want to also collect baseline biometric data at this time, along with assignment of passwords and one or more personal identification numbers, as shown in step 312. The method then proceeds with creation of 3^{rd} party accounts as desired.

Returning to FIG. 1, once an employee is identified and authenticated, the financial module 22 can provide access for the employee to third party services through interface 32. Brokering engine 34 may be used to provide permissions and authorizations for the employee to access third party providers through interface 32. Brokering engine 34 may also be used to mask the identity of the employee from the third party according to rules established by the employer and/or third party. Additionally, the employer may act as a surrogate for the employee using brokering agent 34 to allow access to third party services that would otherwise not be available to the employee, such as access to a bank card, or money transfer services requiring identification that the employee does not have access to. Other examples of services that might be provided include currency brokering services, insurance, data storage, etc.

One or more modules of the system may be used to provide notifications to an employee using a wirelessly connectable device. Examples include notification that a payroll event has been authorized, that payment is available and other information of interest to employee. An employer may also use elements of the system to calculate and assign available time periods for an employee to use the system in order to minimize waiting and otherwise provide for efficient access to the system. Notifications may be provided over elements of private network 10, or over a third-party network.

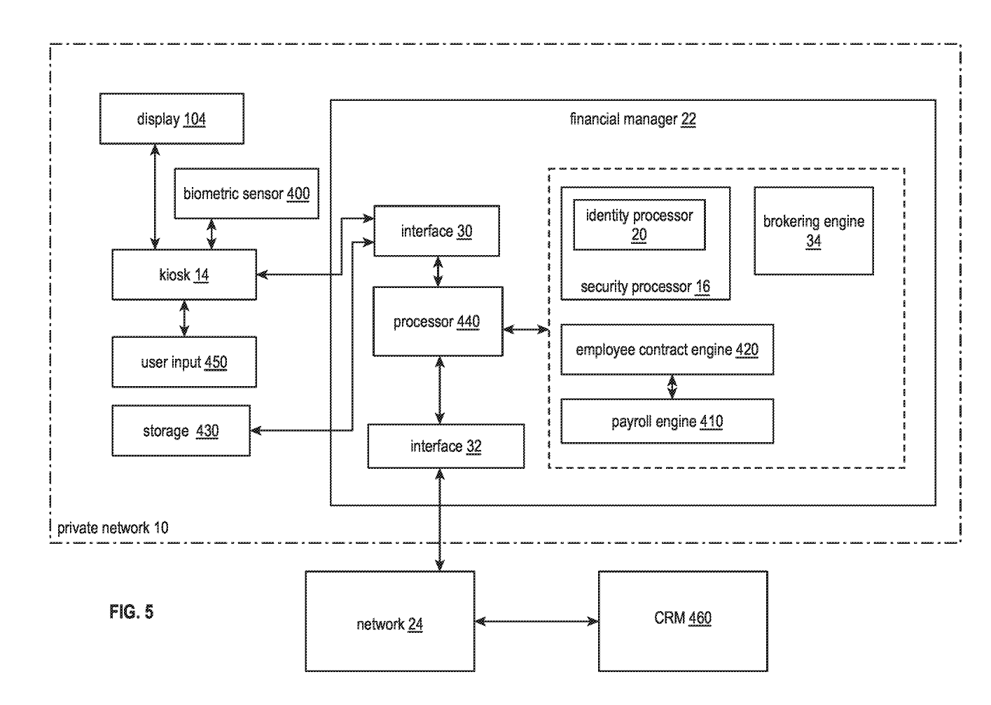

FIG. 5 is a schematic block diagram of an embodiment of financial module 22 in private network 10, that includes interfaces 30 and interface 32, identity processor 20, security processor 16 and brokering engine 34 from FIG. 1. Biometric sensor 400 includes one or more sensors from FIG. 2, including, but not limited to, facial recognition sensor 114, fingerprint sensor 108, camera 110 and EKG pads 112. Biometric sensor 400 and user input 450 function to provide employee information for kiosk 14, which communicates over interface 30 with processor 440.

In addition to the authentication functions of identity processor 10 and security processor 16, financial module 22 includes brokering engine 34, employee contract engine 420 and payroll engine 410. Once a user/employee has been authenticated at kiosk 14, financial module 22 accesses brokering engine 34, employee contract engine 420 and payroll engine 410 as needed to determine an employee's eligibility for system services. For example, financial module 22 may query one or more storage devices for data to determine what an employee's current pay eligibility is, in order to determine payment currently available for withdrawal at kiosk 14. Queried storage devices may be within financial module 22, outside the financial module but still within private network, or they may be housed outside the private network in a third-party database.

Payroll engine 410 may be used to determine pay eligibility, along with other services eligibility based on input from timecard module 20 from FIG. 1, and/or the any employee agreements that apply to that employee. Employee contract engine 420 may be used to consolidate employee agreements and other employee specific terms for use by the payroll engine 410 and/or financial module 22. When identity information, whether in the form of user input or biometric sensor data, is received at processor 440 through interface 30, it directed to security processor 16, which uses identity processor 20 to determine which employee matches the received identity information. Once an employee identity is determined, security processor 16 transmits an authentication request to processor 440, which in turn transmits the request using interface 30 to kiosk 14. Kiosk 14 displays the relevant authentication request to the user using display 100 from FIG. 2, or using other methods described in detail above with reference to FIGS. 1-4.

When requested authentication is received at security processor 16 it is compared with the expected response and when favorable, security processor 16 queries payroll engine 410 and or employee contract engine 420 for permissions related to payment disbursement and other system services. For example, employee contract engine 420 queries one or more employment databases to determine whether proper approvals are in place for various payment forms, whether third party agreements have been properly executed, and whether the employee has provided default instructions. As another example, employee contract engine 420 may receive information from a learning engine to predict which payments/services are most likely to be desired during a transaction.

Once employee contract engine 420 has affirmed proper approvals, financial module 22 may incorporate brokering engine 34 to engage with third party providers. Financial module 22 may, according to previously determined rules, engage third parties as a surrogate for the employee, and/or provide guarantee(s) required by a given third party to engage its services. When financial module 22 is engaging with a third party, brokering agent 34 may also mask the employee's name and other identifying information so as to protect the employee from disclosing his/her identity to the third party.

While elements of FIG. 5 are depicted within financial module 22 or within private network 10, many may be deployed by a third party connected through network 24. For example, CRM 460 (customer relationship management platform) may store one or more of payroll data, payroll rules, employee contracts, and timecard data. In such an example, access to CRM 460 would be provided over an encrypted connection, but each would still be controlled by financial module 22. Additionally, each of the elements of FIG. 5 could be deployed as discrete hardware within financial module 22, as software modules operating on a processor, or as a combination of both. Functions of financial module 22 may be deployed on a single processor, on multiple processors, and as distributed modules operating within private network 10.

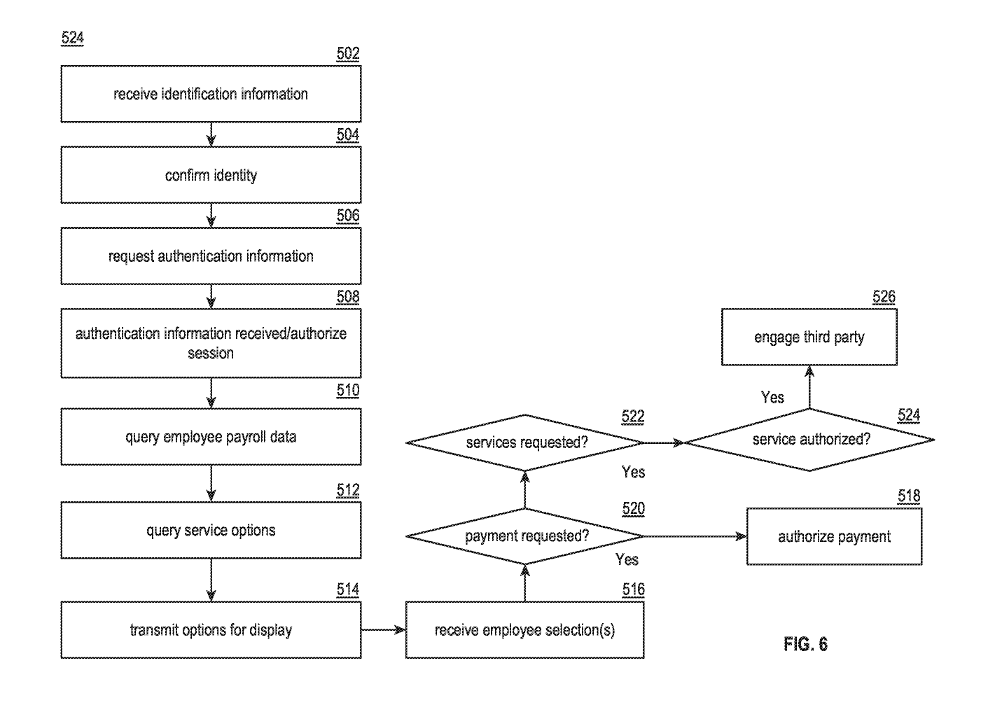

FIG. 6 is a logic diagram of an example of a method for providing automated services in accordance with the present invention. In step 502 identity information related to an employee is received over a for comparison to one or more libraries of users. Identity information may be in the form of a login entry, output from an employee badge reader, biometric information, or a combination thereof and may be received in an encrypted form. The identity information may originate at an employer provided kiosk, from a mobile application executed on a wirelessly connectable device, or from a terminal in the private network. In step 504 the received identity information is decrypted where necessary and compared to a library of authorized users and when the identity information matches an authorized user identity is confirmed in step 504 and the method continues with step 506, where authentication information is determined and transmitted to the user/employee.

When the requested authentication information is received it is compared to expected information, and when there is a match a session is authorized for the employee in step 508. In step 510 employee payroll data for the authorized employee is queried and continues in step 512, where service options for the authorized employee are queried. Service options are then transmitted to the user/employee in step 514, who may receive them at the kiosk, at a wirelessly connectable device, or at another appropriate device in the network.

Employee selections are then received at step 516. When payment is requested and when the payment request is authorized, it is approved in step 518. When the employee selection(s) includes, as shown in step 522, services other than (or in addition to) payment, those services may be authorized, based on a review of previously determined approvals, in step 524. One or more third parties may be engaged to provide those services in step 526.

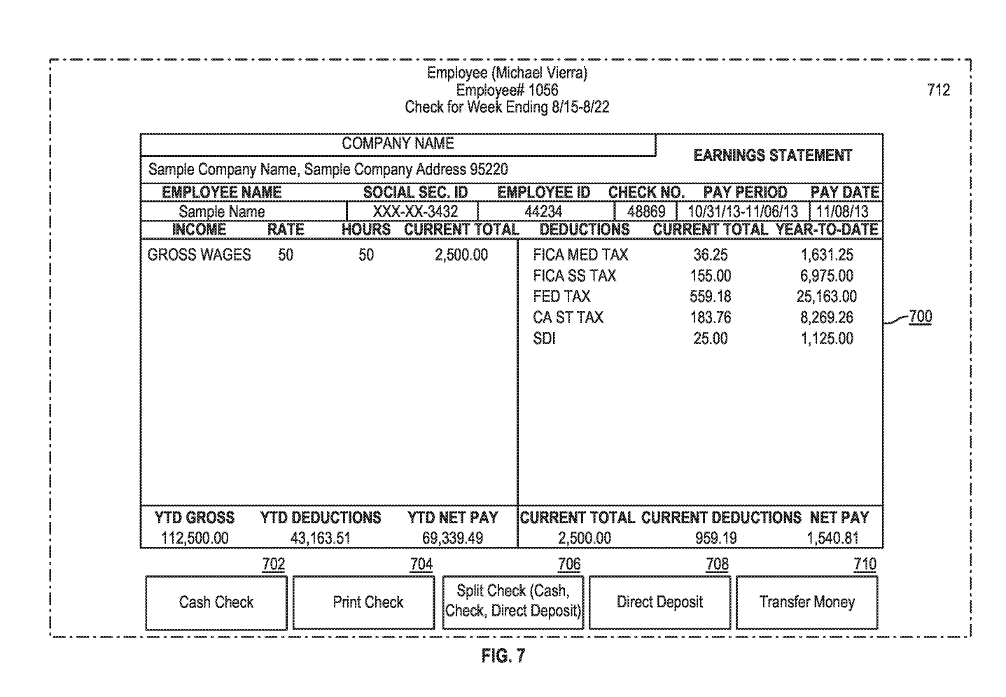

FIG. 7 is a representation of an example interactive display image for use by an employee to make selections after financial module 22 has authorized a session. Display image 712 is displayed on a display, such as display 104 from FIG. 2, which can include a touch screen interface to provide employee input.

An earning statement 700 is provided, along with graphical control elements (in this case option “buttons”) for the employee. In this example the kiosk may be used to cash a check from an outside entity using button 702, print a check from available earnings using button 704, and/or split available earnings between cash and check using button 706. Additional options may be provided, such as direct deposit button 706 and money transfer button 710. Additional and/or alternative options include statements from third parties, retirement accounts, transaction status, etc. When a wirelessly connectable device is used as kiosk 14 the options could change to accommodate its use, such as removing the “cash check” and “split check” options. In addition, when an authorized wirelessly connectable device is within an approved geographic area proximal to a kiosk, the wirelessly connectable device could be used to approve and disburse cash and/or a check.

FIG. 8 provides another representation of an example interactive display for use by an employee to determine what portion of available earnings to receive as cash or check. In this example the employee/user is provided options to receive disbursal in various cash and check ratios.

Disbursal ratios could be dictated according to static rules, such as those discussed above related to FIG. 1, or it could be dictated dynamically based on various employer financial circumstances. For example, an employer's free cash flow may be an input to the disbursal criteria, such that when the employer has significant free cash available the options provided to an employer using the kiosk would include authorization to receive all or most of available pay in the form of cash. The employee might receive an incentive to receive cash instead of check. In one example, the employer chooses to provide cash payment earlier than the check option, or alternatively, a check-based payment earlier than cash. Payment could be made available in any practical time increment. For example, an employee could be provided one half of earned income in cash after some increment of time, such as a day. In another example cash might be available at the end of a work week, whereas cash would be available earlier.

Alternatively, when free cash is limited the employee options would provide for a limit to the percentage of pay receivable in cash. In yet another example, the kiosk could provide for an employer to provide additional services to employees, such as cashing 3^{rd} party financial instruments, subject to possible use fees as dictated by the employer.

In the example above the employer could use its current financial status and projections to meet its objectives while providing various payment options to employees. The financial module could provide for manual control of disbursal criteria, or the process could be mostly or completely automated based on input of cash stores and other financial information.

The employer may also choose to separate employee pay from 3^{rd} party services accessible using the system. For example, an employee may elect to receive pay in cash and then deposit that cash back into the kiosk for payment to a 3^{rd} party, such as those described above. An employee might also be able to receive pay in cash and then load the cash onto a pre-paid card, where the pre-paid card is controlled by a 3^{rd} party financial entity. As an additional example, the employee may choose to prioritize payment of 3^{rd} party obligations such that important bills, such as mortgage payments or rent are paid first, so that pay would only be available once those obligations are current. In the case where the employee is a contractor, taxes and other self-employment obligations could be assigned to an account on the system, or transferred to a third-party financial institution, thus providing some measure of efficiency for the employee.

As may be used herein, the terms “substantially” and “approximately” provide an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices operating in an digital domain or an analog domain, or a combination of both. Such a processing device may be a microprocessor, micro-controller, digital signal processor, microcomputer, analog computer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributed located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for providing automated services on a private network by an employer, the method comprising:
receiving identification information associated with a user;
determining whether the identification information matches the user in a user library;
when the identification information matches a user in a user library, requesting an authentication response from the user;
receiving the requested authentication response;
determining whether the authentication response compares favorably to an expected response;
when the authentication compares favorably to the expected response, receiving pay data associated with the user, wherein the pay data includes information sufficient to determine compensation owed to the user;
based on the pay data for the user, providing available options to the user;
receiving user selections from the user;
determining whether one or more user selections include payment disbursal; and
when one or more user selections includes payment disbursal, authorizing an automated kiosk to disburse payment.

2. The method of claim 1, further comprising:
determining whether one or more received user selections include a financial service other than payment disbursal; and
when one or more user selections include one or more financial services other than payment disbursal, facilitating providing at least one of the one or more financial services.

3. The method of claim 2, wherein one of the one or more financial services is provided by an entity that is not the employer of the user, and further wherein the one of the one or more financial services includes at least one of a currency exchange service, a banking service, a money transfer service, and an insurance service.

4. The method of claim 1, wherein the identification information associated with a user is at least partially biometric information.

5. The method of claim 4, wherein the biometric information is collected by the kiosk.

6. The method of claim 1, wherein the identification information associated with a user is at least partially based on user input.

7. The method of claim 1, wherein the authentication response is at least partially biometric information.

8. The method of claim 7, wherein the biometric information is collected by the kiosk.

9. The method of claim 1, wherein the authentication response is at least partially based on user input.

10. The method of claim 1, wherein the pay data further comprises timecard information.

11. The method of claim 10, wherein the determining compensation owed to the user is at least partially based on timecard information and a previously determined maximum payment disbursal.

12. The method of claim 1, wherein the automated kiosk is used to collect at least a portion of the user information.

13. A method for execution by a first execution unit of an automated financial services system, the method comprises:
receiving a request from a user to access the automated financial services system;
requesting an authentication response from the user;
receiving the requested authentication response;
determining whether the authentication response compares favorably to an expected response;
when the authentication compares favorably to the expected response, querying a storage device for data associated with the user, wherein the data includes payroll information associated with the user, and wherein the data further includes compensation owed to the user;
receiving the data from the storage device;
based on the data, transmitting available options to the user;
receiving one or more user selections from the user;
determining whether the one or more user selections include payment disbursal; and
when one or more user selections includes payment disbursal, authorizing an automated kiosk to disburse payment to the user.

14. The method of claim 13, further comprising:
displaying available options to the user using the automated kiosk.

15. The method of claim 13, further comprising:
displaying available options to the user using a wirelessly connectable device.

16. The method of claim 13, wherein one or more user selections includes payment disbursal in the form of cash, the method further comprising:
authorizing the automated kiosk to disburse at least some cash to the user.

17. The method of claim 16, further comprising:
accessing another storage device for data associated with the user's employer; and based on the data associated with the user's employer, determining an amount of cash
to disburse to the user.

18. The method of claim 17, wherein the data associated with the user's employer includes information sufficient to determine the employer's available cash.

19. The method of claim 17, wherein the data associated with the user's employer includes information sufficient to determine the employer's projected expenses.

20. A system for providing automated services on a private network, the system comprising:
a first module, when operable within a first computing device, causes the first computing device to:
receive a user identifier from a user; and
transmit the user identifier to a second computing device;
a second module, when operable within the first computing device, causes the first computing device to:
receive an authenticator associated with the user from a second computing device;
in response to the authenticator, provide a request for authentication information from the user acquire authentication information associated with the user; and
transmit the authentication information from the user to the second computer;
a third module, when operable within a second computing device, causes the second computing device to:
receive the user identifier from the first computing device;
compare the user identifier to a library of user identifiers;
determine the user associated with the user identifier; and
when the user associated with the user identifier is determined, transmit an authenticator associated with the user to the first computing device;
a fourth module, when operable within the second computing device, causes the second computing device to:
receive the authentication information from the first computer;
compare the received authentication information associated with the user to stored authentication information for the user; and
when the received authentication information compares favorably to the stored authentication information, authenticate the user;
a fifth module, when operable within the second computing device, causes the second computing device to:
retrieve payroll data for the user, wherein the payroll data includes timecard data for the user;
based on the payroll data, determine pay data for the user;
transmit a payment disbursal authorization to the first computing device, wherein the payment disbursal authorization is for a payment determined by the second computing device and further wherein the payment is based at least partially on the pay data; and
a sixth module, when operable within the first computing device, causes the first computing device to:
initiate disbursal of payment to the user.
